(19) United States
(12) Patent Application Publication
(10) Pub. No.: US 2022/0205227 A1
(43) Pub. Date: Jun. 30, 2022

(54) AUTOMATIC ANGLE STOP

(71) Applicant: AS America, Inc., Piscataway, NJ (US)

(72) Inventors: Eric Soberano, Barnegat, NJ (US); Benjamin Smith, Milwaukee, WI (US); Verne H. Myers, Fort Wayne, IN (US)

(73) Assignee: AS America, Inc., Piscataway, NJ (US)

(21) Appl. No.: 17/602,179

(22) PCT Filed: Apr. 7, 2020
(86) PCT No.: PCT/US2020/027028

§ 371 Date: Oct. 7, 2021

Related U.S. Application Data
(60) Provisional application No. 62/831,341, filed on Apr. 9, 2019.

(51) Int. Cl. E03B 7/07; G01F 1/56

(52) U.S. Cl. CPC E03B 7/071; G01F 1/56

(57) ABSTRACT

An automatic angle stop assembly, comprising a fluid inlet port and a fluid outlet port; a controller; a solenoid valve; a flow sensor; and a power source; wherein the flow sensor and solenoid valve are in flow communication with the fluid inlet port and fluid outlet port; and the flow sensor, the controller, the solenoid valve, and the power source are in electrical communication. The automatic angle stop assembly is useful upstream of a toilet tank, an ice machine, a refrigerator ice maker, a washing machine or a dishwasher.

The disclosure is directed towards a water supply cut-off device, and in particular, an automatic angle stop configured for use with a toilet tank.

### BACKGROUND

Angle stops, shut-off valves, and similar devices are employed in bathrooms, positioned in a water line upstream of a toilet tank and faucets. A toilet tank angle stop is generally left in an open position. This allows for automatic refill of the toilet tank with fluid after a toilet flush. A toilet tank fill valve is configured to start and stop fluid flow into the toilet tank and to provide a desired level of fluid in a refilled tank. A toilet tank angle stop may be closed to cut off water flow to a toilet tank in order to repair or replace the toilet or associated valves, floats, etc.

Under certain conditions, for instance failure conditions such as a flush valve or a fill valve not operating correctly, water may continually flow into the toilet tank, through a damaged flush valve or an overflow tube and into the bowl and out the trapway, resulting in excess water usage. According to some estimates, a constantly running toilet can waste about 200 gallons of water per day.

Desired is an improved angle stop that may stop water flow to toilet tank automatically in the event of failure conditions.

### SUMMARY

Accordingly, disclosed is an automatic angle stop assembly, comprising a fluid inlet port and a fluid outlet port; a controller; a solenoid valve; a flow sensor; and a power source; wherein the flow sensor and solenoid valve are in flow communication with the fluid inlet port and fluid outlet port; and the flow sensor, the controller, the solenoid valve, and the power source are in electrical communication.

Also disclosed is a toilet tank assembly and a toilet assembly comprising the automatic angle stop assembly.

### BRIEF DESCRIPTION OF THE DRAWINGS

The disclosure described herein is illustrated by way of example and not by way of limitation in the accompanying FIGURES. For simplicity and clarity of illustration, features illustrated in the figures are not necessarily drawn to scale. For example, the dimensions of some features may be exaggerated relative to other features for clarity. Further, where considered appropriate, reference labels have been repeated among the FIGURES to indicate corresponding or analogous elements.

FIG. 1 depicts an automatic angle stop assembly according to one embodiment.

### DETAILED DISCLOSURE

In some embodiments, one or more elements of the automatic angle stop assembly may be positioned in an interior space of a housing. The housing may comprise any material, for instance a plastic such as one or more of a polyolefin, a polyamide, a polyester, a polycarbonate. The housing may be configured to be attached to a bathroom wall or baseboard. The housing may also be configured to be in-line with a fluid inlet and not be attached to a wall or baseboard.

In some embodiments, substantially all of the angle stop assembly elements may be positioned in an interior space of a housing. The fluid inlet and fluid outlet ports may be positioned at the exterior of a housing.

In certain embodiments a housing may have dimensions of about 158 mm×110 mm×62 mm. Each of these dimensions may independently vary by about ±2%, ±3%, ±4%, ±5%, ±6%, ±7%, ±8%, ±9%, ±10%, ±11% or more.

The fluid inlet port and fluid outlet port are in flow communication. In some embodiments, the flow sensor and solenoid valve are positioned between the inlet port and outlet port, are in flow communication with each other and are in flow communication with the inlet and outlet ports. In some embodiments, the flow sensor may be positioned upstream of the solenoid valve. In other embodiments, the flow sensor may be positioned downstream of the solenoid valve.

The controller (microcontroller) is in electrical communication with both the flow sensor and the solenoid valve. The controller and the solenoid valve are in electrical communication with a power source. The controller is configured to send an electrical “close” signal to the solenoid valve, i.e. close the solenoid valve, under certain conditions, thereby shutting off and stopping fluid flow.

Electrical communication may be via a wired connection or may be via a wireless connection.

The power source may be a battery, in some embodiments a primary battery or a rechargeable battery. A battery may be conveniently positioned in an interior space of a housing. In other embodiments, the angle stop assembly may be powered by an electrical circuit, for instance by a standard home electrical circuit.

In some embodiments, the flow sensor may comprise a propeller and operate via the Hall Effect. In other embodiments, the flow sensor may comprise a wheel and operate via the Hall Effect. In further embodiments, the flow sensor may be an ultrasonic sensor having emitter(s)/receiver(s) to measure fluid flow. In other embodiments, the flow sensor may comprise a flow switch. The flow sensor is in electrical communication with the controller. The controller may be configured to determine boolean fluid flow status and/or a fluid flow rate from data communicated from the flow sensor. Flow sensors and controllers are commercially available.

In some embodiments, the angle stop assembly may have a timer or clock associated with it. In some embodiments, a timer may be a time-to-digital converter, or “time digitizer”. For instance, the assembly may be able to determine a fluid flow rate. Additionally, the assembly may be configured to determine a certain fluid volume “X” delivered in a defined time period “Y”. The assembly may be configured to close the solenoid valve and stop fluid flow under conditions wherein greater than a certain volume X of fluid flow is detected within a certain time period Y.

In some embodiments, the controller may be configured to close the solenoid valve and shut off fluid flow when the assembly detects a volume of >X gallons of fluid flow within a time period of ≤Y minutes. In some embodiments, values for X and Y may be set by an end user (an operator). In other embodiments, values for X and Y are preset in the assembly and may or may not be adjusted by an end user. A value for X may be a typical volume for a toilet tank, for example about 1.6 gallons, or about 3.6 gallons for older toilet tanks. A value for Y may represent a time somewhat greater than a typical time necessary to fill a toilet tank, for example greater than about 0.75 minutes to greater than about 1.50 minutes.

In another embodiment, the controller may be configured to close the solenoid valve and shut off fluid flow when greater than a certain volume of fluid flow is detected prior to a recognition that fluid flow has stopped. For example, the controller may be configured to close the solenoid valve when >X gallons of fluid flow is detected prior to a detection that fluid flow has stopped. This may be a single flush event.

In some embodiments, the angle stop assembly may be positioned upstream of and in flow communication with a toilet tank. In other embodiments, the angle stop assembly may be positioned in any desired water line. In other embodiments, the angle stop assembly may be positioned upstream of and in flow communication with a washing machine, an ice machine, a refrigerator ice maker, a dishwasher, etc.

For instance, a user may perform a toilet flush, wherein a flush valve is opened, the tank is emptied, and a fill valve is activated to re-fill the toilet tank with water. In some situations, the flush valve may not close properly, resulting in water continually flowing through the open valve into the bowl and out the trapway. A present angle stop assembly may be configured to recognize this failure and shut off water flow to the tank automatically, thereby preventing water waste.

In some embodiments, the controller may be configured to close the solenoid valve when the angle stop assembly detects >about 1.5 gallons, >about 1.6 gallons, >about 1.8 gallons, >about 2.0 gallons, >about 2.2 gallons, >about 2.5 gallons, >about 2.8 gallons, >about 3.0 gallons, >about 3.2 gallons, >about 3.4 gallons, >about 3.6 gallons, >about 3.9 gallons, >about 4.1 gallons, >about 4.3 gallons, or >about 4.5 gallons, or more, prior to a detection that fluid flow has stopped.

In some embodiments, the controller may be configured to close the solenoid valve when the angle stop assembly detects >about 1.5 gallons, >about 1.6 gallons, >about 1.8 gallons, >about 2.0 gallons, >about 2.2 gallons, >about 2.5 gallons, >about 2.8 gallons, >about 3.0 gallons, >about 3.2 gallons, >about 3.4 gallons, >about 3.6 gallons, >about 3.9 gallons, >about 4.1 gallons, >about 4.3 gallons, or >about 4.5 gallons, or more, within a time period of ≤about 0.50 minutes, ≤about 0.65 minutes, ≤about 0.75 minutes, ≤about 1.00 minutes, ≤about 1.25 minutes, ≤about 1.50 minutes, ≤about 2.00 minutes, ≤about 2.50 minutes, ≤about 3.00 minutes, ≤about 3.50 minutes, ≤about 4.00 minutes, or ≤about 4.50 minutes, or more.

In another embodiment, the controller may be configured to close the solenoid valve and shut off fluid flow when less than a certain volume of fluid flow is detected prior to a recognition that fluid flow has stopped. This may also indicate a failure. For example, the controller may be configured to close the solenoid valve when <X gallons of fluid flow is detected prior to a detection that fluid flow has stopped. This may be a single flush event.

In some embodiments, the controller may be configured to close the solenoid valve when the angle stop assembly detects <about 1.5 gallons, <about 1.6 gallons, <about 1.8 gallons, <about 2.0 gallons, <about 2.2 gallons, <about 2.5 gallons, <about 2.8 gallons, <about 3.0 gallons, <about 3.2 gallons, <about 3.4 gallons, <about 3.6 gallons, <about 3.9 gallons, <about 4.1 gallons, <about 4.3 gallons, or <about 4.5 gallons, or more, prior to a detection that fluid flow has stopped.

The term “assembly detects” means the flow sensor and controller in combination, in some embodiments together with a timer or clock. For example the flow sensor may communicate data to the controller which may perform a function to determine a value such as flow rate, flow volume, flow time, etc.

In some embodiments, the angle stop assembly may be configured to detect a system abnormal state. The controller may be configured to close the solenoid valve to shut off fluid flow when an abnormal state is detected.

An abnormal state, which may also be termed a “failure state”, may arise when greater than a certain volume of fluid X is delivered in less than or equal to a certain time period Y, as discussed above. Another abnormal state may arise if fluid flow, even at a low rate, is detected for greater than or equal to a certain defined time period.

For example, in some embodiments, a controller may be configured to close the solenoid valve if fluid flow is detected, at any flow rate, for a period of ≥about 0.75 minutes, ≥about 0.80 minutes, ≥about 0.90 minutes, ≥about 1.00 minutes, ≥about 1.20 minutes, ≥about 1.50 minutes, ≥about 1.55 minutes, ≥about 1.60 minutes, ≥about 1.65 minutes, ≥about 1.70 minutes, ≥about 1.75 minutes, ≥about 1.80 minutes, ≥about 1.85 minutes, ≥about 1.90 minutes, ≥about 2.00 minutes, or more.

In some embodiments, fluid flow of about 0.25 gpm (gallons per minute), about 0.20 gpm, about 0.15 gpm, about 0.10 gpm, or lower may be detected.

In certain embodiments, the automatic angle stop assembly may be associated with and upstream or downstream of a conventional manual angle stop. In other embodiments, the automatic angle stop assembly may replace a conventional manual angle stop. The angle stop assembly may positioned in-line in an inlet hose to a toilet tank or other apparatus as is a manual angle stop.

In some embodiments, the automatic angle stop assembly may also comprise an electronic actuator coupled to the solenoid valve and configured to open and close the solenoid valve. In some embodiments, such an electronic actuator may be positioned on an exterior of a housing, visible to and operable by a user. An electronic actuator may be a toggle switch, a button, a lever, a knob, etc. in electrical communication with the solenoid valve.

In some embodiments, the angle stop assembly may comprise a manual bypass actuator configured to open or close the solenoid in the event of an electrical or electronics failure. Electrical or electronics failures include a power outage, drained battery, broken controller, etc. A manual bypass actuator may likewise comprise a toggle switch, a button, a lever, a knob, and the like. A manual bypass actuator may be positioned on an exterior of a housing and visible and operable by a user.

Thus, in some embodiments, the automatic angle stop assembly may be configured to close the solenoid valve automatically upon detection of undesired fluid flow, and the solenoid valve may be configured to be manually opened/closed as desired.

In some embodiments, one or more indicator lights may be positioned on an exterior of a housing and visible to a user. An indicator light may indicate if the solenoid valve is in an open or closed position, or may indicate a status of a battery.

In some embodiments, the automatic angle stop assembly may be retrofitted into an existing water line.

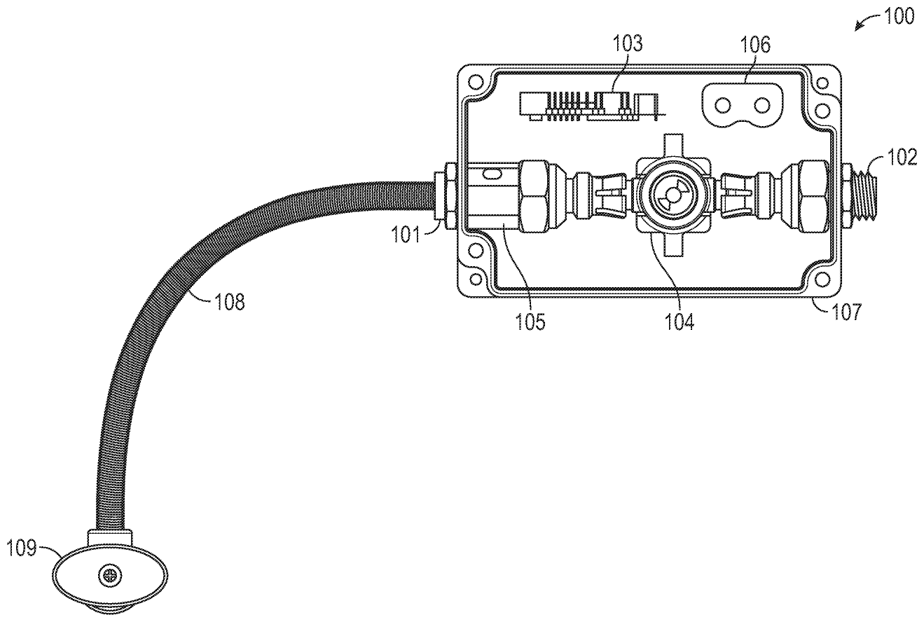

FIG. 1 shows an automatic angle stop assembly 100 from a front view according to an embodiment of the invention. The assembly contains a housing 107. Positioned within the housing are a flow sensor 105, solenoid valve 104 downstream of the flow sensor, battery 106 and controller 103. The flow sensor 105, solenoid 104 and battery 106 may be in electrical communication via wired connections (not shown). A fluid inlet 101 is positioned upstream of fluid outlet 102, both positioned on the exterior of housing 107. Also shown are a conventional manual angle stop 109 upstream of the automatic angle stop assembly, and in fluid communication with the angle stop assembly via hose 108. Housing 107 may have a cover (not shown).

Following are some embodiments of the invention.

In a first embodiment, disclosed is an automatic angle stop assembly, comprising a fluid inlet port and a fluid outlet port; a controller; a solenoid valve; a flow sensor; and a power source; wherein the flow sensor and solenoid valve are in flow communication with the fluid inlet port and fluid outlet port; and the flow sensor, the controller, the solenoid valve, and the power source are in electrical communication.

In a second embodiment, disclosed is an angle stop assembly according to embodiment 1, wherein the controller, solenoid valve and flow sensor are positioned in an interior space of a housing, and the fluid inlet and fluid outlet ports are positioned exterior to the housing.

In a third embodiment, disclosed is an angle stop assembly according to embodiments 1 or 2, wherein the flow sensor is positioned upstream of the solenoid valve. In a fourth embodiment, disclosed is an angle stop assembly according to embodiments 1 or 2, wherein the flow sensor is positioned downstream of the solenoid valve.

In a fifth embodiment, disclosed is an angle stop assembly according to any of the preceding embodiments, wherein the power source is a battery positioned in the interior space of a housing. In a sixth embodiment, disclosed is an angle stop assembly according to any of the preceding embodiments, wherein the electrical communication is via a wire or a wireless connection.

In a seventh embodiment, disclosed is an angle stop assembly according to any of the preceding embodiments, wherein the assembly is configured to detect a fluid abnormal state. In an eighth embodiment, disclosed is an angle stop assembly according to any of the preceding embodiments, wherein the assembly is configured to detect a fluid abnormal state; and wherein the controller is configured to close the solenoid valve when an abnormal state is detected.

In a ninth embodiment, disclosed is an angle stop assembly according to any of the preceding embodiments, wherein the assembly comprises a timer. In a tenth embodiment, disclosed is an angle stop assembly according to any of the preceding embodiments, wherein the controller is configured to close the solenoid valve when the assembly detects fluid flow for a period of time≥Y minutes, wherein Y may be set by an end user, for instance wherein Y is ≥about 0.8 minutes, ≥about 1.0 minutes, or ≥about 1.5 minutes.

In an eleventh embodiment, disclosed is an angle stop assembly according to any of the preceding embodiments, wherein the controller is configured to close the solenoid valve when the assembly detects a volume of >about X gallons of fluid flow over a time period of ≤about Y minutes, wherein X and Y may be set by an end user.

In a twelfth embodiment, disclosed is an angle stop assembly according to any of the preceding embodiments, wherein the controller is configured to close the solenoid valve when the assembly detects a volume>about X gallons of fluid flow prior to detecting that fluid flow has stopped.

In a thirteenth embodiment, disclosed is an angle stop assembly according to any of the preceding embodiments, wherein the controller is configured to close the solenoid valve when the assembly detects a volume<about X gallons of fluid flow prior to detecting that fluid flow has stopped.

In a fourteenth embodiment, disclosed is an angle stop assembly according to any of the preceding embodiments, wherein the controller is configured to close the solenoid valve when the assembly detects a volume of >about 3.6 gallons or >about 1.6 gallons of fluid flow over a time period of ≤about 2.0 minutes.

In a fifteenth embodiment, disclosed is an angle stop assembly according to any of the preceding embodiments, wherein the controller is configured to close the solenoid valve when the assembly detects a volume of >about 3.6 gallons or >about 1.6 gallons of fluid flow prior to the assembly detecting a fluid flow stop.

In a sixteenth embodiment, disclosed is an angle stop assembly according to any of the preceding embodiments, wherein the controller is configured to close the solenoid valve when the assembly detects a volume of <about 3.6 gallons or <about 1.6 gallons of fluid flow prior to the assembly detecting a fluid flow stop.

In a seventeenth embodiment, disclosed is an angle stop assembly according to any of the preceding embodiments, wherein the assembly is configured to be in flow communication with and upstream of a toilet tank, a washing machine, an ice machine, a refrigerator ice maker or a dishwasher.

In an eighteenth embodiment, disclosed is an angle stop assembly according to any of the preceding embodiments, wherein the assembly comprises an electronic actuator, wherein the electronic actuator is in electrical communication with the solenoid valve and is configured to open and close the solenoid valve.

In a nineteenth embodiment, disclosed is an angle stop assembly according to any of the preceding embodiments, wherein the assembly comprises a manual bypass actuator configured to open or close the solenoid valve in an event of an electrical or electronics failure.

In a twentieth embodiment, disclosed is an angle stop assembly according to any of the preceding embodiments, wherein the solenoid valve is configured to be automatically closed to prevent undesired fluid flow, and wherein the solenoid valve may be manually opened or closed by a user.

In a twenty-first embodiment, disclosed is an angle stop assembly according to any of the preceding embodiments, wherein the assembly comprises an indicator light, the indicator light configured to indicate if the solenoid valve is open or closed.

In a twenty-second embodiment, disclosed is an angle stop assembly according to any of the preceding embodiments, wherein the assembly is configured to be in flow communication with a manual angle stop.

In a twenty-third embodiment, disclosed is a toilet tank assembly, the toilet tank in flow communication with the angle stop assembly according to any of the preceding embodiments.

In a twenty-fourth embodiment, disclosed is a toilet assembly, comprising a bowl and a toilet tank according to the twenty-third embodiment.

The term “coupled” means that an element is “attached to” or “associated with” another element. Coupled may mean directly coupled or coupled through one or more other elements. An element may be coupled to an element through two or more other elements in a sequential manner or a non-sequential manner. The term “via” in reference to “via an element” may mean “through” or “by” an element. Coupled or “associated with” may also mean elements not directly or indirectly attached, but that they “go together” in that one may function together with the other.

The term “flow communication” means for example configured for liquid or gas flow there through. The terms “upstream” and “downstream” indicate a direction of gas or fluid flow, that is, gas or fluid will flow from upstream to downstream.

The term “electrical communication” may be synonymous with “electrically coupled” or “electrically connected” and may mean an element may send or receive electricity or electronic signals to another element, either via a wired connection or a wireless connection. The term “associated with” may mean “coupled”, i.e. “electrically coupled”.

The term “towards” in reference to a of point of attachment, may mean at exactly that location or point or, alternatively, may mean closer to that point than to another distinct point, for example “towards a center” means closer to a center than to an edge.

The term “like” means similar and not necessarily exactly like. For instance “ring-like” means generally shaped like a ring, but not necessarily perfectly circular.

The articles “a” and “an” herein refer to one or to more than one (e.g. at least one) of the grammatical object. Any ranges cited herein are inclusive. The term “about” used throughout is used to describe and account for small fluctuations. For instance, “about” may mean the numeric value may be modified by ±0.05%, ±0.1%, ±0.2%, ±0.3%, ±0.4%, ±0.5%, ±1%, ±2%, ±3%, ±4%, ±5%, ±6%, ±7%, ±8%, ±9%, ±10% or more. All numeric values are modified by the term “about” whether or not explicitly indicated. Numeric values modified by the term “about” include the specific identified value. For example “about 5.0” includes 5.0.

The term “substantially” is similar to “about” in that the defined term may vary from for example by ±0.05%, ±0.1%, ±0.2%, ±0.3%, ±0.4%, ±0.5%, ±1%, ±2%, ±3%, ±4%, ±5%, ±6%, ±7%, ±8%, ±9%, ±10% or more of the definition; for example the term “substantially perpendicular” may mean the 90° perpendicular angle may mean “about 90°”. The term “generally” may be equivalent to “substantially”.

Features described in connection with one embodiment of the disclosure may be used in conjunction with other embodiments, even if not explicitly stated.

Embodiments of the disclosure include any and all parts and/or portions of the embodiments, claims, description and FIGURES. Embodiments of the disclosure also include any and all combinations and/or sub-combinations of embodiments.

All U.S. patent applications, published patent applications and patents referred to herein are hereby incorporated by reference.

1. An automatic angle stop assembly, comprising
a fluid inlet port and a fluid outlet port;
a controller;
a solenoid valve;
a flow sensor; and
a power source;
wherein
the flow sensor and solenoid valve are in flow communication with the fluid inlet port and fluid outlet port; and
the flow sensor, the controller, the solenoid valve, and the power source are in electrical communication.

2. The angle stop assembly according to claim 1, wherein the controller, solenoid valve and flow sensor are positioned in an interior space of a housing, and the fluid inlet and fluid outlet ports are positioned exterior to the housing.

3. The angle stop assembly according to claim 1, wherein the assembly is configured to detect a fluid abnormal state.

4. The angle stop assembly according to claim 3, wherein the controller is configured to close the solenoid valve when an abnormal state is detected.

5. The angle stop assembly according to claim 1, wherein the assembly comprises a timer.

6. The angle stop assembly according to claim 1, wherein the assembly comprises an indicator light, the indicator light configured to indicate if the solenoid valve is open or closed.

7. The angle stop assembly according to claim 1, wherein the assembly is configured to be in flow communication with a manual angle stop.

8. The angle stop assembly according to claim 1, wherein the assembly comprises an electronic actuator, wherein the electronic actuator is in electrical communication with the solenoid valve and is configured to open and close the solenoid valve.

9. The angle stop assembly according to claim 1, wherein the assembly is configured to be in flow communication with and upstream of a toilet tank, a washing machine, an ice machine, a refrigerator, or a dishwasher.

10. The angle stop assembly according to claim 1, wherein the assembly comprises a manual bypass actuator configured to open or close the solenoid valve in an event of an electrical or electronics failure.

11. The angle stop assembly according to claim 1, wherein the solenoid valve is configured to be automatically closed to prevent undesired fluid flow, and wherein the solenoid valve may be manually opened or closed by an end user.

12. The angle stop assembly according to claim 1, wherein the controller is configured to close the solenoid valve when the assembly detects fluid flow for a period of time≥about Y minutes, wherein Y may be set by an end user.

13. The angle stop assembly according to claim 1, wherein the controller is configured to close the solenoid valve when the assembly detects a volume of >about X gallons of fluid flow over a time period of ≤about Y minutes, wherein X and Y may be set by an end user.

14. The angle stop assembly according to claim 1, wherein the controller is configured to close the solenoid valve when the assembly detects a volume>about X gallons of fluid flow prior to detecting that fluid flow has stopped.

15. The angle stop assembly according to claim 1, wherein the controller is configured to close the solenoid valve when the assembly detects a volume<about X gallons of fluid flow prior to detecting that fluid flow has stopped.

16. The angle stop assembly according to claim 1, wherein the controller is configured to close the solenoid valve when the assembly detects a volume of >about 3.6 gallons or >about 1.6 gallons of fluid flow over a time period of ≤about 2.0 minutes.

17. The angle stop assembly according to claim 1, wherein the controller is configured to close the solenoid valve when the assembly detects a volume of >about 3.6 gallons or >about 1.6 gallons of fluid flow prior to the assembly detecting a fluid flow stop.

18. The angle stop assembly according to claim 1, wherein the controller is configured to close the solenoid valve when the assembly detects a volume of <about 3.6 gallons or <about 1.6 gallons of fluid flow prior to the assembly detecting a fluid flow stop.

19. A toilet tank assembly, the toilet tank in flow communication with the angle stop assembly according to claim 1.

20. A toilet assembly, comprising a bowl and a toilet tank according to claim 19.
